(19) United States
(12) Patent Application Publication
(10) Pub. No.: US 2025/0216035 A1
(43) Pub. Date: Jul. 3, 2025

(54) HYDROGEN CARTRIDGE TANK AND HYDROGEN CONSUMPTION SYSTEM

(71) Applicant: TOYOTA JIDOSHA KABUSHIKI KAISHA, Toyota-shi Aichi-ken (JP)

(72) Inventor: Tomoki NAKASHIMA, Nagoya-shi Aichi-ken (JP)

(73) Assignee: TOYOTA JIDOSHA KABUSHIKI KAISHA, Toyota-shi Aichi-ken (JP)

(21) Appl. No.: 18/973,168

(22) Filed: Dec. 9, 2024

(30) Foreign Application Priority Data
Dec. 27, 2023 (JP) 2023-221117

(51) Int. Cl. F17C 13/04

(52) U.S. Cl. CPC F17C 13/04; F17C 2201/0109; F17C 2205/0317; F17C 2221/012; F17C 2270/0168; F17C 2270/0184

(57) ABSTRACT

A hydrogen cartridge tank includes a tank body that stores hydrogen, the tank body including a container portion that stores hydrogen, a fusible plug configured to open when a predetermined temperature is reached to release the hydrogen within the container portion through a release port, and a control member including a surface at a position facing the release port.

### CROSS-REFERENCE TO RELATED APPLICATION

This application claims priority to Japanese Patent Application No. 2023-221117 filed on Dec. 27, 2023, incorporated herein by reference in its entirety.

### BACKGROUND

### 1. Technical Field

The present disclosure relates to a hydrogen cartridge tank and a hydrogen consumption system to which the hydrogen cartridge tank is attached and which receives provision of hydrogen.

### 2. Description of Related Art

Japanese Unexamined Patent Application Publication No. 2002-195499 (JP 2002-195499 A) discloses that a hydrogen tank is provided with a safety valve, and a fusible alloy is disposed in the safety valve. According to this, when the temperature of the surroundings rises due to a fire or the like, the temperature is quickly transferred to the fusible alloy, causing the fusible alloy to melt, such that hydrogen in the hydrogen tank is quickly released to the outside through the safety valve, thereby suppressing damage or the like to the hydrogen tank.

### SUMMARY

It is necessary to consider the orientation of a release port of the safety valve, such that gas released from the safety valve is not directed with great force toward people in the surroundings. However, hydrogen cartridge tanks that are removable and that are applicable in a variety of applications are expected to be stored upright when in a removed state, with the displacement position, displacement angle, and so forth, of the tanks differing depending on the application when attached to the application, and accordingly the orientation of the release port of the safety valve cannot be generalized.

In light of the above problem, the present disclosure provides a hydrogen cartridge tank that can suppress effects on the surroundings caused by hydrogen released from a safety valve that is activated when the hydrogen cartridge tank is subjected to thermal effects such as flames and so forth. The present disclosure also provides a hydrogen consumption system, which is an application in which hydrogen is supplied by a hydrogen cartridge tank.

Through diligent study, the inventor discovered that by reducing the force of gas released from the safety valve (reducing release energy), the effects of the release of the gas on the surroundings can be reduced (making it less likely to cause trouble) as compared to when the force is not reduced.

According to a first aspect of the present disclosure, a hydrogen cartridge tank includes a tank body that stores hydrogen, in which the tank body includes a container portion that stores hydrogen, a fusible plug that is configured to open when a predetermined temperature is reached, so as to release the hydrogen in the container portion through a release port, and a control member that includes a surface at a position facing the release port.

In the hydrogen cartridge tank according to the first aspect of the present disclosure, the tank body may further include a neck and a partitioning member, and the partitioning member may be interposed between the neck and the fusible plug, with both ends of the partitioning member butting against the control member.

Also, according to a second aspect of the present disclosure, a hydrogen cartridge tank includes a tank body that stores hydrogen, and a case that houses the tank body, in which the tank body includes a container portion that stores hydrogen, and a fusible plug that is configured to open when a predetermined temperature is reached, so as to release the hydrogen in the container portion through a release port, and in which the case includes a control member that includes a surface at a position facing the release port.

In the hydrogen cartridge tank according to the second aspect of the present disclosure, the control member may be a handle of the hydrogen cartridge tank.

In the hydrogen cartridge tank according to the second aspect of the present disclosure, the tank body may further include a neck and a partitioning member, and the partitioning member may be interposed between the neck and the fusible plug, with both ends of the partitioning member butting against the control member.

According to a third aspect of the present disclosure, a hydrogen consumption system includes a housing unit that houses a hydrogen cartridge tank, in which the hydrogen cartridge tank includes a tank body that stores hydrogen, and the tank body includes a container portion that stores hydrogen, a release port, and a fusible plug that is configured to open when a predetermined temperature is reached, so as to release the hydrogen in the container portion through the release port, and the housing unit includes a control member that includes a surface at a position facing the release port.

In the hydrogen consumption system according to the third aspect of the present disclosure, the tank body may further include a neck and a partitioning member, and the partitioning member may be interposed between the neck and the fusible plug, with both ends of the partitioning member butting against the control member.

According to the present disclosure, when the hydrogen tank is subjected to thermal effects from flames or the like, and the fusible plug is activated, the control member can reduce release energy of the hydrogen that is released, thereby suppressing the effects on the surroundings.

### BRIEF DESCRIPTION OF THE DRAWINGS

Features, advantages, and technical and industrial significance of exemplary embodiments will be described below with reference to the accompanying drawings, in which like signs denote like elements, and wherein:

FIG. 1 is a diagram illustrating a configuration of a hydrogen consumption system 10;

FIG. 2A is an external view of the hydrogen cartridge tank 50;

FIG. 2B is a cross-sectional view taken along a direction of an axial line O of the hydrogen cartridge tank 50;

FIG. 3 is a perspective view illustrating a gas release control member 100;

FIG. 4 is a cross-sectional view illustrating the gas release control member 100; and

FIG. 5 is a cross-sectional view illustrating a gas release control member 110.

### DETAILED DESCRIPTION OF EMBODIMENTS

### 1. Basic Structure of Hydrogen Consumption System

First, a basic structure of a hydrogen cartridge tank, and a hydrogen consumption system that is an application in which the hydrogen cartridge tank is attached and hydrogen is used, will be described. Specific matters relating to reduction in energy of gas release, which is a characteristic feature of the present disclosure, will be described later, and the basic structures of the hydrogen cartridge tank and the hydrogen consumption system will be described here.

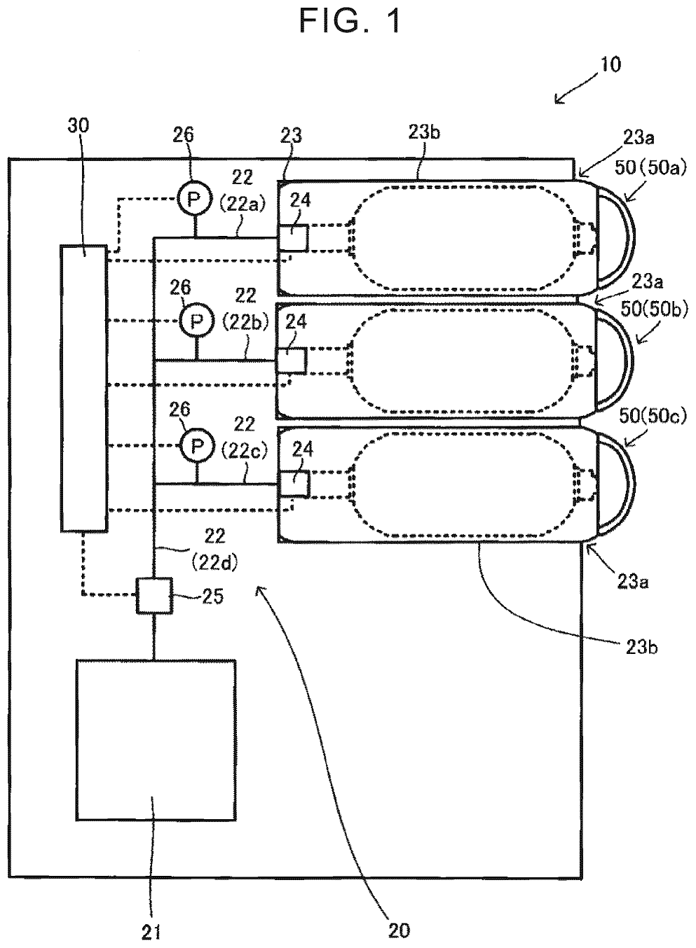

FIG. 1 conceptually illustrates a configuration of a hydrogen consumption system 10 according to an embodiment. Such a hydrogen consumption system 10 has hydrogen cartridge tanks 50 which are supply sources of hydrogen, a hydrogen consumption device 20 which is a supply destination of the hydrogen, and a control device 30. This hydrogen consumption system 10 is a system that supplies hydrogen stored in the hydrogen cartridge tanks 50 to a fuel cell 21 included in the hydrogen consumption device 20 to generate electricity. Further, in the present embodiment, the hydrogen cartridge tanks 50 are configured so as to be detachably attached to the hydrogen consumption device 20.

This will be described in detail below.

### 1.1. Hydrogen Cartridge Tank

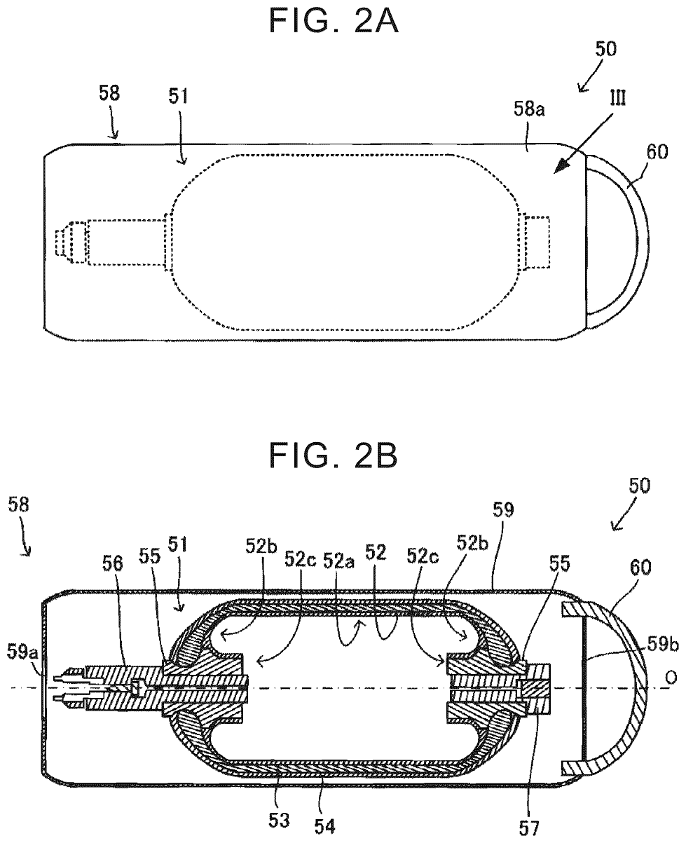

The hydrogen cartridge tank 50 is a container that stores gas to be supplied (hydrogen in the present embodiment) in a liquid state or a gaseous state. FIGS. 2A and 2B are diagrams for description thereof. FIG. 2A is an external view of the hydrogen cartridge tank 50 (a tank body 51 contained therein is indicated by a dotted line), and FIG. 2B is a cross-sectional view taken along a direction of an axial line O of the hydrogen cartridge tank 50. As can be understood from these drawings, in the embodiment, the hydrogen cartridge tank 50 has the tank body 51 and a case 58 having an outer surface 58a. The tank body 51 also includes a liner 52, a reinforcing layer 53, and a protective layer 54 that make up a container portion, and further has necks 55, an opening/closing valve 56, and a fusible plug 57.

### 1.1.1. Liner

The liner 52 is a hollow member that defines internal space in the container portion of the tank body 51, and is cylindrical in the present embodiment. The liner 52 has a body portion 52a that is formed with a substantially constant diameter, openings at both ends of the body portion 52a are narrowed by side end portions 52b that are dome-shaped, and the necks 55 are disposed at openings 52c that are narrowed.

It is sufficient for the liner 52 to be made of a material that can hold that which is accommodated in the internal space thereof (e.g., hydrogen) without leaking, and known materials can be used. Specifically, the material may be nylon resin, polyethylene-based synthetic resin, or metal such as stainless steel or aluminum, or the like, for example. Among these, the material making up the liner is a synthetic resin, from the perspective of reducing the weight of the tank, in some embodiments.

In some embodiments, the thickness of the liner 52 is 0.5 mm to 3.0 mm, although not limited thereto in particular.

### 1.1.2. Reinforcing Layer

The reinforcing layer 53 is one of the members that make up the container portion, and is made up of multiple layers of fibers that are layered and impregnated with resin that is cured. The layers of fiber are made up of fiber bundles wound around an outer periphery of the liner 52 in multiple layers to a predetermined thickness. The thickness of the reinforcing layer 53 and the number of turns of the fiber bundles are not limited in particular, since these are determined by the required strength thereof, but the thickness thereof is around 10 mm to 30 mm.

### Fiber Bundles

Carbon fibers are used as the fiber bundles for the reinforcing layer 53, and the fiber bundles have strip shapes in which the carbon fibers form bundles with predetermined cross-sectional shapes (e.g., rectangular cross-sections). The cross-sectional shape may be a rectangle with a width of about 6 mm to 20 mm and a thickness of about 0.1 mm to 0.3 mm, although not specifically limited thereto in particular. An example of the amount of carbon fibers included in one fiber bundle is around 36,000 carbon fibers, although not limited thereto in particular.

### Impregnating Resin

The resin with which the fibers (fiber bundle) are impregnated and cured in the reinforcing layer 53 is not limited in particular, as long as the strength of the fibers can be increased. Specific examples thereof include thermosetting resins cured by heat, such as epoxy resins containing amine-based or anhydride-based curing accelerators and rubber-based reinforcing agents, unsaturated polyester resins, or the like. Also, another example is a resin composition including an epoxy resin as a main agent, which is cured by a curing agent being mixed therein. According to this, the resin composition, which is a mixture, reaches and permeates the fiber layers between the time of mixing the main agent with the curing agent, and the time of curing the mixture, so as to be automatically cured.

1.1.3. Protective layer

The protective layer 54 may be disposed on an outer periphery of the reinforcing layer 53 as one of the members making up the container portion, as necessary. When the protective layer 54 is provided, glass fiber, for example, is wound and impregnated with resin. The impregnating resin can be considered in the same way as that of the reinforcing layer 52. Thus, impact resistance can be imparted to the tank body 51.

The thickness of the protective layer 54 can be around 1.0 mm to 1.5 mm, although not limited thereto in particular.

### 1.1.4. Necks, Opening/Closing Valve, Fusible Plug

The necks 55 are members attached to each of the two openings 52c of the liner 52, disposed at both ends of the liner 52 in the direction of the axial line O, and function as openings for communication between the inside and the outside of the container portion, with valves disposed therein. The opening/closing valve 56 is disposed in one of the necks 55, and the fusible plug 57 is disposed in the other neck 55.

The material making up the necks 55 is not limited in particular, as long as the required strength is obtained, and examples thereof include stainless steel, aluminum, and so forth.

The opening/closing valve 56 is closed when the hydrogen cartridge tank 50 is not attached to the hydrogen consumption system 10, and is opened by being pressed by a push rod (omitted from illustration) when the hydrogen cartridge tank 50 is attached to the hydrogen consumption device 20 of the hydrogen consumption system 10, which will be described later.

The fusible plug 57 is sometimes called a fusible alloy safety valve, and is a valve that opens when a predetermined temperature is reached, to release gas (hydrogen) within the container portion (liner 52). The basic form of the fusible plug 57 is not limited in particular, and a known form can be used. Further, the fusible plug 57 may be a metal material that includes lead or tin. Moreover, the fusible plug 57 may melt at more than 110° C. Note however, that specific forms for controlling the hydrogen released from the fusible plug 57 will be described later.

### 1.1.5. Case

The case 58 is a member that encloses a portion of the tank body 51 and forms an outer shell of the hydrogen cartridge tank 50, and has an enclosure 59 and a handle 60.

The enclosure 59 is a cylindrical member, and is configured such that at least a portion of the tank body 51 can be housed therein. Also, the enclosure 59 is provided with a hole 59a at a position facing the opening/closing valve 56 of the tank body 51 that is housed, and is configured such that the opening/closing valve 56 can be externally accessed. Further, the enclosure 59 is provided with a hole 59b at a position facing the fusible plug 57 of the tank body 51, and the fusible plug 57 is exposed from the hole 59b, and is configured such that hydrogen released from the fusible plug 57 can be externally released. That is to say, the case 58 houses the liner 52 of the tank body 51, and accommodates the fusible plug 57 so as to be exposed (note that specific forms and so forth regarding hydrogen released from the fusible plug 57 will be described later).

The handle 60 is an arch-shaped member disposed at an end portion of the enclosure 59 on the fusible plug 57 side, and a user can hold this handle 60 to carry the hydrogen cartridge tank 50 and to attach/detach the hydrogen cartridge tank 50 to/from the hydrogen consumption system 10.

### 1.1.6 Others

In the present embodiment, the cartridge tank 50 is a portable hydrogen tank configured to be carriable, and the size and weight thereof are set from this perspective. Allowable pressure of the tank body 51 is not limited in particular, but from the perspective of being portable yet capable of supplying a greater amount of hydrogen, the tank body can be capable of storing hydrogen at an allowable pressure of more than 20 MPa and no more than 70 MPa.

In the hydrogen consumption system 10 according to the present embodiment, a plurality of the hydrogen cartridge tanks 50 (e.g., three) is provided, with each tank body 51 being filled with hydrogen. An example of three hydrogen cartridge tanks 50 being disposed is described herein, denoted by reference signs 50a, 50b, and 50c, to distinguish thereamong. The tank bodies 51 of these hydrogen cartridge tanks 50 may all be of the same capacity, or tanks of different capacities may be included.

### 1.2. Hydrogen Consumption Device

The hydrogen consumption device 20 is a device to which hydrogen is supplied from hydrogen cartridge tanks 50, and that receives and consumes hydrogen. As illustrated in FIG. 1, the hydrogen consumption device 20 according to the present embodiment includes the fuel cell 21, supply channels 22, housing units 23, connection devices 24, an injector 25, and pressure gauges 26.

An example of a hydrogen consumption device is a device that achieves its purpose by generating electricity using hydrogen as one of fuels thereof. Examples thereof include a power generation and/or storage device that uses a fuel cell, a vehicle powered by a fuel cell, and so forth, although not limited thereto.

### 1.2.1. Fuel Cell

The fuel cell 21 is equipment that consumes hydrogen gas supplied thereto, and receives a supply of hydrogen from the hydrogen cartridge tanks 50 while also receiving a supply of air from an air hole that is omitted from illustration, so as to generate electricity. The specific configuration of the fuel cell 21 is not limited in particular, and known configurations can be used.

### 1.2.2. Supply Channels

The supply channels 22 are routes that guide gas from the hydrogen cartridge tanks 50 to the fuel cell 21, and are made up of pipes. In the present embodiment, each of the hydrogen cartridge tanks 50a, 50b, and 50c is connected to the fuel cell 21. Here, pipes 22a, 22b, and 22c extending from the hydrogen cartridge tanks 50a, 50b, and 50c, respectively, join together to form a single pipe 22d, which is connected to the fuel cell 21.

### 1.2.3. Housing Units

The housing units 23 are portions in which the hydrogen cartridge tanks 50 are housed, when the hydrogen cartridge tanks 50 are connected to the hydrogen consumption device 20. The housing units 23 are spaces in which the hydrogen cartridge tanks 50 are disposed, and are spaces each surrounded by an inner wall 23b having an opening 23a through which the hydrogen cartridge tank 50 can be inserted and removed. The connection devices 24 are each disposed on bottom walls of the housing units 23, opposite to the openings 23a.

### 1.2.4. Connection Devices

The connection devices 24 are disposed at portions of connection of the supply channels 22 and the tank bodies 51 of the hydrogen cartridge tanks 50, and are connected to the opening/closing valves 56 of the tank bodies 51 described above and also control the opening and closing of the opening/closing valves 56 of the tank bodies 51. The connection devices 24 have rod-shaped push rods (omitted from illustration) that are disposed in the housing units 23, and when the hydrogen cartridge tanks 50 are housed in the housing units 23, the push rods press valve bodies disposed inside the opening/closing valves 56, thereby opening the opening/closing valves 56 so as to be connected to the supply channels 22.

### 1.2.5. Injector

The injector 25 is disposed on the supply channel 22 (the supply channel 22d in the present embodiment), between the connection device 24 and the fuel cell 21, and controls the supply of hydrogen to the fuel cell 21. An example of a specific form of the injector is a flow regulator valve, although not limited thereto in particular.

### 1.2.6. Pressure Gauges

The pressure gauges 26 are pressure gauges that measure in-channel pressure of the supply channels 22 (pressure inside the pipes) between the connection devices 24 and the injector 25. Although the specific form of the pressure gauges 26 is not limited in particular, a configuration is made such that pressure value data that is obtained can be transmitted to the control device 30.

### 1.3. Control Device

The control device 30 is a device that controls each piece of equipment of the hydrogen consumption system 10 so as to maintain appropriate operations, and is configured to be able to communicate with the push rods of the connection devices 24, the injector 25, the pressure gauges 26, and so forth.

The control device 30 includes a central processing unit (CPU) that is a processor and performs computation, random-access memory (RAM) that functions as a work area, read-only memory (ROM) that functions as a recording medium, a reception unit that is an interface through which the control device 30 receives information either wired or wirelessly, and a transmission unit that is an interface through which the control device 30 externally sends information either wired or wirelessly. The control device 30 further obtains information from each piece of equipment, performs computation that is necessary to operate the hydrogen consumption system 10, and transmits control signals to the equipment as necessary.

Such a control device 30 can typically be made up of a computer.

2. Hydrogen Release from Safety Valve According to Present Disclosure

It is necessary to assume that the hydrogen cartridge tank may be exposed to flames for some reason in a state of being attached to a hydrogen consumption system and/or in a state of being not being attached thereto. For this reason, a safety measure has been taken by deploying a fusible plug (safety valve) to discharge hydrogen from the tank body (container portion) when a certain temperature is reached.

At this time, hydrogen is released as a gas (i.e., hydrogen gas) from the fusible plug, and since this hydrogen gas has considerable force, conventionally (with fixed hydrogen tanks), direction of release is set so as to reduce effects on the surroundings. However, hydrogen cartridge tanks that are removable and that can be applied to a variety of applications are expected to be stored upright when in a state of being removed, and in differing disposing positions, disposing angles, and so forth, of the tanks when attached to applications, depending on the application, and accordingly the orientation of release hydrogen gas from the safety valve cannot be generalized. In contrast, in the present disclosure, the force of the hydrogen gas released from the safety valve is reduced (release energy is reduced), thereby reducing the effects of the release of the hydrogen gas on the surroundings as compared to when the force is not reduced. Specific examples to this end will be described below.

### 2.1. First Example (Mode According to Tank Body)

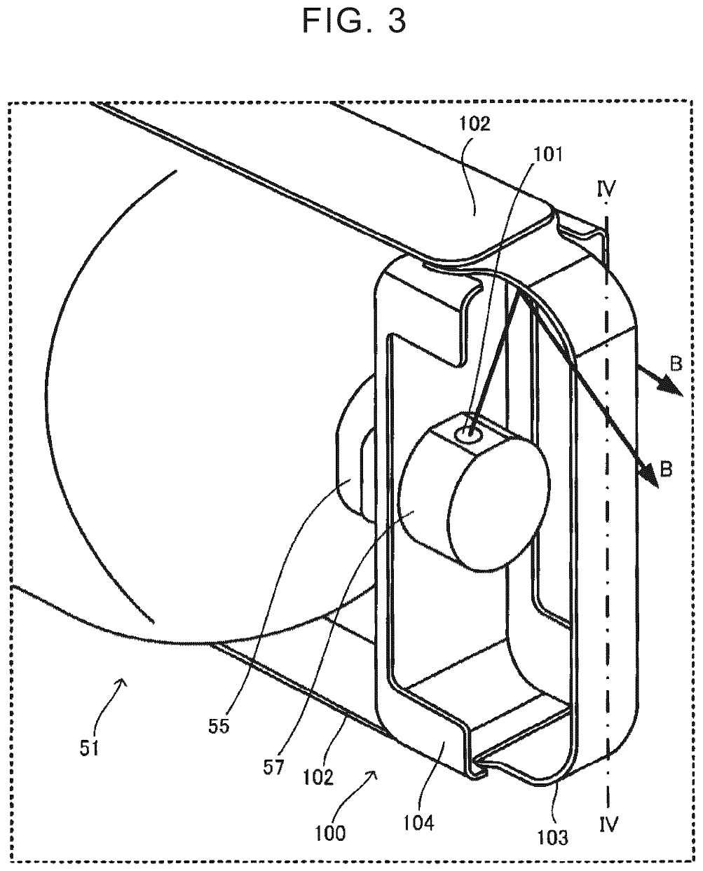

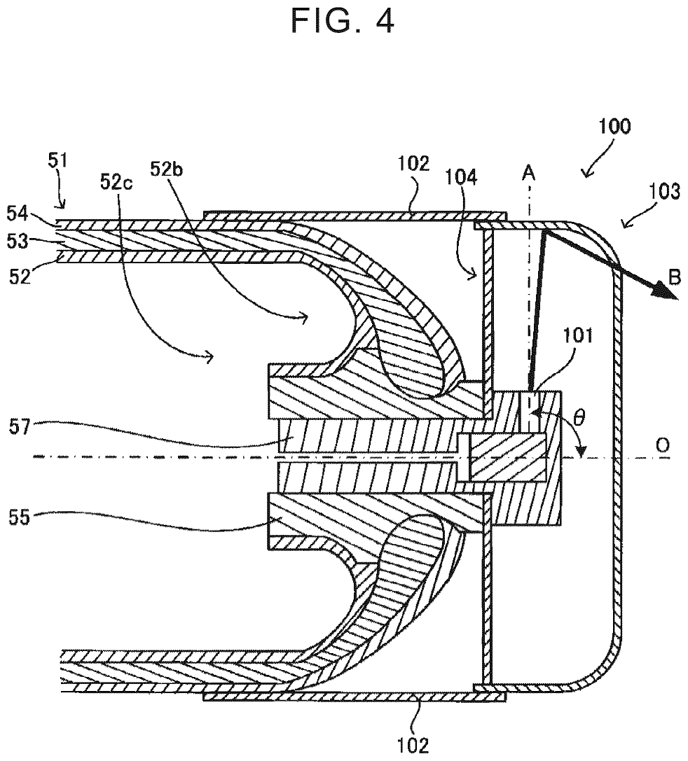

The tank body 51 can be given as a first specific example of the above hydrogen gas release according to the present disclosure. The tank body 51 includes a gas release control member 100 in addition to the basic configuration described above. FIG. 3 is a perspective view of the tank body 51 as viewed from a direction indicated by arrow III in FIG. 2A. That is to say, FIG. 3 is a diagram centering in on a portion including the side end portion 52b of the tank body 51 on which side the fusible plug 57 is disposed. FIG. 4 is a cross-sectional view taken along line IV-IV in FIG. 3 and the axial line O, centering in on the gas release control member 100 and the vicinity thereof.

As can be understood from FIGS. 3 and 4, the gas release control member 100 according to the present example is disposed in the tank body 51, and includes a release port 101 provided in the fusible plug 57, holding members 102, a control member 103, and a partitioning member 104.

### 2.1.1. Release Port

The release port 101 is an opening provided in the fusible plug 57 through which hydrogen gas is released. The release port 101 is provided in the fusible plug 57 and is an opening through which hydrogen gas is released when the fusible plug 57 is activated, and determines the direction in which the hydrogen gas is first released. In the present example, the release port 101 is opened such that an angle θ of the hydrogen gas emission direction relative to the axial line O of the tank body 51 is 90 degrees (i.e., in a radial direction of the tank body that is cylindrical), as indicated by line A in FIG. 4. In some embodiments, this θ is about 90 degrees, but does not have to be strictly 90 degrees, and it is sufficient for the angle with respect to the axial line O to be at least a certain angle or more. In some embodiments, it is sufficient for θ to be 45 degrees or more, or 60 degrees or more, although not limited in particular thereto. Increasing θ to a certain degree in this way makes it easier to reduce the energy of the hydrogen gas by lengthening the route for the hydrogen gas to be released and facilitating collision of the hydrogen gas with the control member, and so forth.

Note that the term “emission” here means releasing gas with directionality. More specifically, the emission direction (direction of line A) is an axial line direction of a channel that forms the release port 101.

### 2.1.2. Holding Member

The holding members 102 are members that hold the control member 103 and the partitioning member 104. In the present example, the holding members 102 are plate-like members that are long in one direction, and two holding members 102 are disposed so as to clamp the tank body 51 from both sides in a diameter direction of the cylindrical shape thereof. More specifically, the holding members 102 that are plate-like are disposed such that one plate surface of each thereof is in contact with the protective layer 54, and a longitudinal direction of the plates is parallel to the axial line O, with end portions thereof extending so as to protrude toward the fusible plug 57 side. One holding member 102 and the other holding member 102, of the two holding members 102, are disposed on opposite sides of the axial line O.

Now, the material making up the holding members 102 is a material that can retain the shape thereof without melting, even when exposed to high temperatures such as flames and so forth. In some embodiments, the material making up the holding members 102 is metal, although not specifically limited thereto in particular. The same holds regarding materials of the control member 103 and the partitioning member 104, which will be described later.

### 2.1.3. Control Member

The control member 103 is a member that controls the direction of the hydrogen released from the release port 101. In the present example, the control member 103 is a plate-like member that is long in one direction, with both ends in the longitudinal direction bent 90 degrees with respect to a side of one of the plate surfaces, and formed such that the end portions thereof extend toward the tank body 51.

Such a control member 103 is disposed with the two end portions thereof that are bent being held by ends of the two holding members 102, respectively, such that space between the end portions that are bent extends in the diameter direction of the tank body 51. At this time, the plate surface of the control member 103 is disposed so as to face the release port 101. Thus, the released hydrogen gas strikes the surface of the control member 103, thereby reducing the energy of release thereof, and further the hydrogen gas is dispersed, whereby effects of the released gas on the surroundings can be suppressed.

### 2.1.4. Partitioning Member

The partitioning member 104 is a member that controls the direction of the hydrogen released from the release port 101. In the present example, the partitioning member 104 is a plate-like member that is long in one direction, and is formed such that both ends on short sides are bent 90 degrees toward one plate surface side (the side on which the release port 101 is disposed).

This partitioning member 104 is held such that a central portion in the longitudinal direction is interposed between the neck 55 and the fusible plug 57, and also both ends thereof in the longitudinal direction are held butting against the control member 103. Thus, a line connecting the release port 101 and the control member 103 (line A in FIG. 4), and the container portion of the tank body 51 are separated by the partitioning member 104, and the hydrogen gas that is released can be suppressed from heading toward the container portion due to striking the partitioning member 104.

### 2.1.5 Effects, etc.

According to the gas release control member 100, when the fusible plug 57 is activated to release hydrogen gas, the hydrogen gas is emitted from the release port 101 as indicated by arrows B in FIGS. 3 and 4, and the hydrogen gas that is emitted strikes (collides with) the control member 103, causing the direction thereof to be changed and to be released in directions away from the container portion. According to this, the hydrogen gas that is released collides with the control member 103 and the energy of the release is reduced, such that the degree to which the released hydrogen gas affects the surroundings can be suppressed. Also, the hydrogen gas is dispersed after colliding with the control member 103, and accordingly the effects thereof are further suppressed.

Furthermore, due to the partitioning member 104 being provided, the hydrogen gas emitted from the release port 101 is suppressed from advancing toward the container portion side, and accordingly even when the hydrogen gas is accompanied by flames, for example, the flames will be suppressed from reaching the container portion and causing a state of further overheating. Note that the term “emission” as used here refers to releasing gas with directionality, as described above.

### 2.2. Second Example (Mode According to Case)

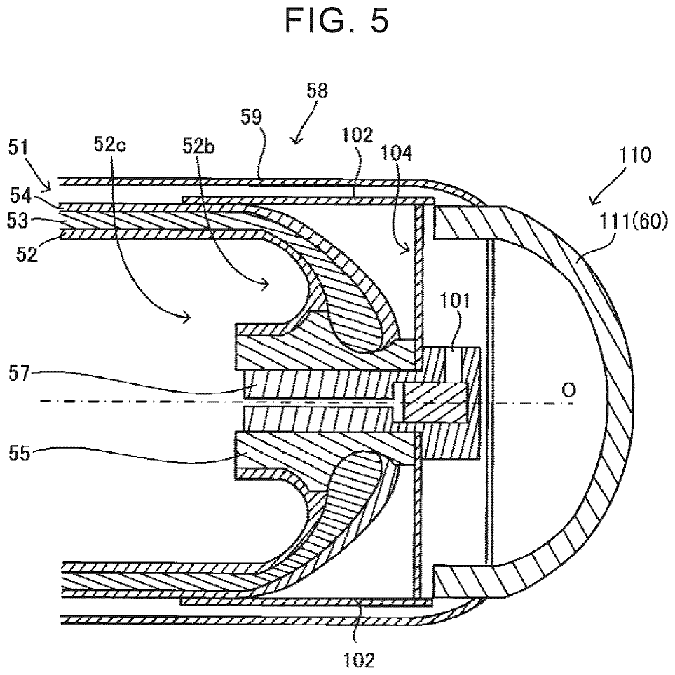

The tank body 51 and the case 58 can be given as a second specific example of the above hydrogen gas release according to the present disclosure. In the present example, the tank body 51 and the case 58 are provided with a gas release control member 110, in addition to the basic configuration described above. FIG. 5 is a diagram centering in on the gas release control member 110 and the vicinity thereof, from the same perspective as in FIG. 4.

As can be understood from FIG. 5, the gas release control member 110 according to the present example is disposed in the tank body 51 and the case 58, and includes the release port 101 provided in the fusible plug 57, the holding members 102, a control member 111, and the partitioning member 104. Now, the release port 101, the holding members 102, and the partitioning member 104 can be considered to be the same as those in the gas release control member 100 described above, and accordingly are denoted by the same reference signs, and description thereof will be omitted.

In the present example, the control member 111 is disposed in place of the control member 103 provided in the gas release control member 100 described above. The control member 111 is provided to the enclosure 59 of the case 58. Other than the control member 111 being provided to the case 58, the shape, material, layout (positional relationship with respect to the release port 101), and so forth, can be considered to be the same as those of the control member 103 described above.

This gas release control member 110 also provides the same effects as the gas release control member 100 described above.

Also, in the present example, the control member 111 may also function as the handle 60 of the case 58, thereby enabling the number of parts to be reduced.

### 2.3. Third Example (Mode According to Hydrogen Consumption Device)

The tank body 51 and the hydrogen consumption device 20 can be given as a third specific example of the above hydrogen gas release according to the present disclosure. In the present example, the gas release control member includes the above release port 101, the holding members 102, and the partitioning member 104. Further, in the gas release control member according to the present example, the inner wall 23b of the housing unit 23 of the hydrogen consumption device 20 is used as the control member. That is to say, the hydrogen gas discharged from the release port 101 advances in the radial direction of the container portion of the tank body 51 in the same way as described above, and collides with the inner wall 23b of the housing unit 23 which functions as the control member. Also, the inner wall 23b has a surface at a position facing the release port 101.

Thus, when the fusible plug 57 is activated and hydrogen gas is released, the hydrogen gas is emitted from the release port 101, and the hydrogen gas that is emitted strikes (collides with) the inner wall 23b of the housing unit 23 that functions as the control member, causing the direction thereof to be changed and to be released in directions away from the container portion. According to this, the hydrogen gas that is released collides with the control member and the energy of the release is reduced, such that the degree to which the released hydrogen gas affects the surroundings can be suppressed. Also, the hydrogen gas is dispersed after colliding with the control member, and accordingly the effects thereof are further suppressed. Furthermore, due to the partitioning member 104 being provided, the hydrogen gas emitted from the release port 101 is suppressed from advancing toward the container portion side, and accordingly even when the hydrogen gas is accompanied by flames, for example, the flames will be suppressed from reaching the container portion and causing a state of further overheating.

What is claimed is:

1. A hydrogen cartridge tank comprising a tank body that stores hydrogen, wherein the tank body includes
a container portion that stores hydrogen,
a fusible plug that is configured to open when a predetermined temperature is reached, so as to release the hydrogen in the container portion through a release port, and
a control member that includes a surface at a position facing the release port.

2. The hydrogen cartridge tank according to claim 1, wherein the tank body further includes a neck and a partitioning member, and the partitioning member is interposed between the neck and the fusible plug, with both ends of the partitioning member butting against the control member.

3. A hydrogen cartridge tank comprising:
a tank body that stores hydrogen; and
a case that houses the tank body, wherein:
the tank body includes
a container portion that stores hydrogen, and
a fusible plug that is configured to open when a predetermined temperature is reached, so as to release the hydrogen in the container portion through a release port; and
the case includes a control member that includes a surface at a position facing the release port.

4. The hydrogen cartridge tank according to claim 3, wherein the control member is a handle of the hydrogen cartridge tank.

5. The hydrogen cartridge tank according to claim 3, wherein the tank body further includes a neck and a partitioning member, and the partitioning member is interposed between the neck and the fusible plug, with both ends of the partitioning member butting against the control member.

6. A hydrogen consumption system comprising a housing unit that houses a hydrogen cartridge tank, wherein the hydrogen cartridge tank includes a tank body that stores hydrogen,
the tank body includes
a container portion that stores hydrogen,
a release port, and
a fusible plug that is configured to open when a predetermined temperature is reached, so as to release the hydrogen in the container portion through the release port, and
the housing unit includes a control member that includes a surface at a position facing the release port.

7. The hydrogen consumption system according to claim 6, wherein the tank body further includes a neck and a partitioning member, and the partitioning member is interposed between the neck and the fusible plug, with both ends of the partitioning member butting against the control member.
